(19) United States
(12) Patent Application Publication
(10) Pub. No.: US 2011/0218117 A1
(43) Pub. Date: Sep. 8, 2011

(54) Enhanced Immunosorbent Spot Test Device and Method of Using Same

(76) Inventor: Arnold J. AQUILINO, Encinitas, CA (US)

(21) Appl. No.: 13/042,413

(22) Filed: Mar. 7, 2011

Related U.S. Application Data
(60) Provisional application No. 61/310,992, filed on Mar. 5, 2010.

(51) Int. Cl. C40B 30/04; C40B 60/12

(52) U.S. Cl. 506/9; 506/39

(57) ABSTRACT

A device used for immunosorbent spot testing. The present invention makes use of a membrane and carrier to test for a multiplex of analytes and is read visually without the use of an optical reader. The membrane comprises of a plurality of specific analyte detectors which each contain a calibrated antigen. The calibrated antigen comprises of a plurality of binding sites which bind a plurality of specific analyte to be tested for. The bound specific analyte is marked with conjugate and further bound with chromogen to provide a visual indiciator as a result of presence of the specific analyte.

The current application claims a priority to the U.S. Provisional Patent application Ser. No. 61/310,992 filed on Mar. 5, 2010.

### FIELD OF THE INVENTION

This invention relates generally to a device used for immunosorbent spot testing. The present invention makes use of a membrane to test for a multiplex of analytes and is read visually without the use of an optical reader.

### BACKGROUND OF THE INVENTION

Traditional methods of immunosorbent spot testing involve a well within or on a solid surface such as a microtiter plate, biochip, or glass slide. The well is coated with immobilized specific antigens which are used to bind specific antibodies. The specimen of interest is then added to the well and incubated for a period of time. After the incubation period, the antibodies of interest will bind to the antigens and non-bound antibodies will be washed away. A detecting antibody is then added to the well to attach to the bound antigens and antibodies. A substrate is then added to expose the detecting antibodies. This technique often requires many steps to detect target analytes. The present invention allows users to simultaneously test for various specific antibodies within a single specimen without the need of an optical reader.

### BRIEF DESCRIPTION OF THE PRIOR ART

With regards to U.S. Pat. No. 5,395,754, this patent incorporates a “calibration zone” for standardizing the reading the degree of concentration. The patent specifies nitrocellulose or polystyrene carriers and the results are read on an optical reader. For US Patent Application 20040049351, this patent specifies a microtiter plate and requires an optical reader. For US Patent Application 20040241776, this patent specifies the “binding of specific antibodies” to a microtiter plate. The results are read on an optical reader and the patent seems to be very specific to various plant proteins. The present invention binds specific antigens, not antibodies, to the membrane. For U.S. Pat. No. 4,803,154, this patent specifies the use of a hydrophobic polymer sheet and requires an optical reader. I use a hydrophilic membrane and read the results without any equipment. For US Patent Application 20090253586, this patent specifies an “optically clear carrier” and requires an optical reader for the results. My membrane is opaque white, not clear, and is read visually. For European Patent EP0957359B1, this patent refers to the use of a microtiter plate. Finally, for European Patent EP1371412A1, this patent refers to the use of microarrays, biochips, or microplates and requires an optical reader.

### BRIEF DESCRIPTION OF THE DRAWINGS

FIG. 1 is a perspective view of the enhanced immunosorbent spot test device showing the carrier and the membrane.

FIG. 2 is a left-side view of the present invention.

FIG. 3 is a top view of the present invention.

FIG. 4 is a specific analyte detector calibrated to detect for sample analyte A.

FIG. 5 is a specific analyte detector receiving a plurality of site blockers followed by the positioning of site blockers on the membrane and excess site blockers washed away.

FIG. 6 is a specific analyte detector receiving a specimen followed by specific analyte A binding to a plurality of binding sites and excess analytes washed away.

FIG. 7 is a specific analyte detector receiving conjugate 1 followed by conjugate 1 binding to specific analyte A and excess conjugate 1 washed away.

FIG. 8 is a specific analyte detector receiving conjugate 2 followed by conjugate 2 binding to conjugate 1 and excess conjugate 2 washed away.

FIG. 9 is a specific analyte detector receiving chromogen followed by chromogen binding to conjugate 2 and conjugate 1. Furthermore, excess chromogen is washed away.

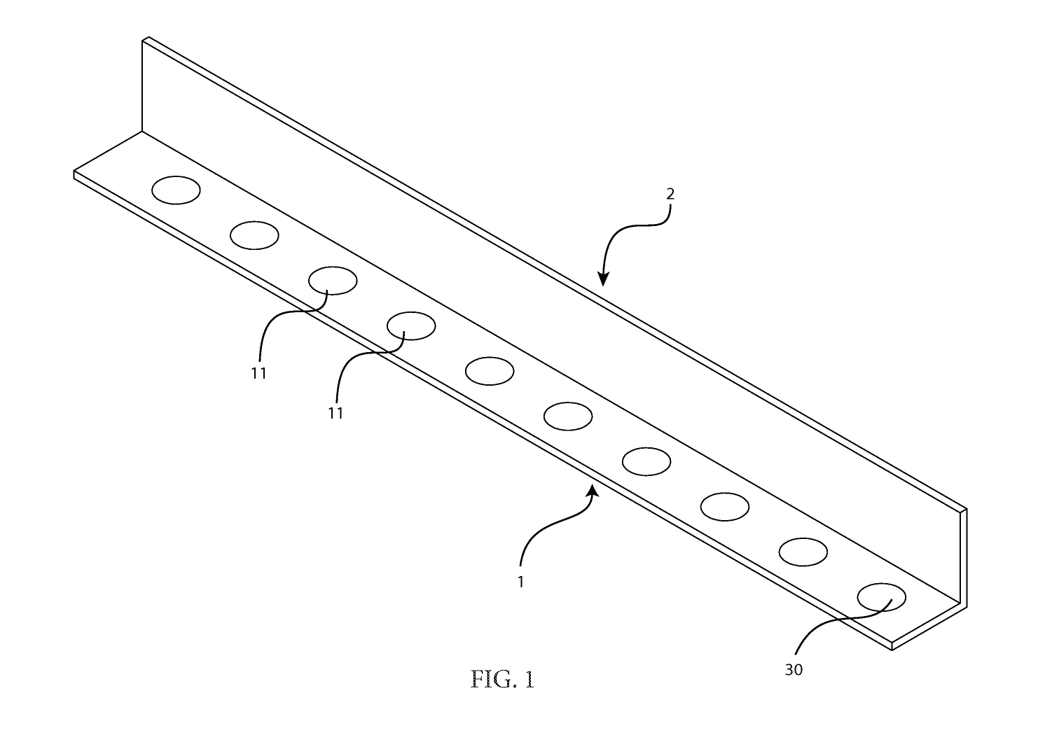

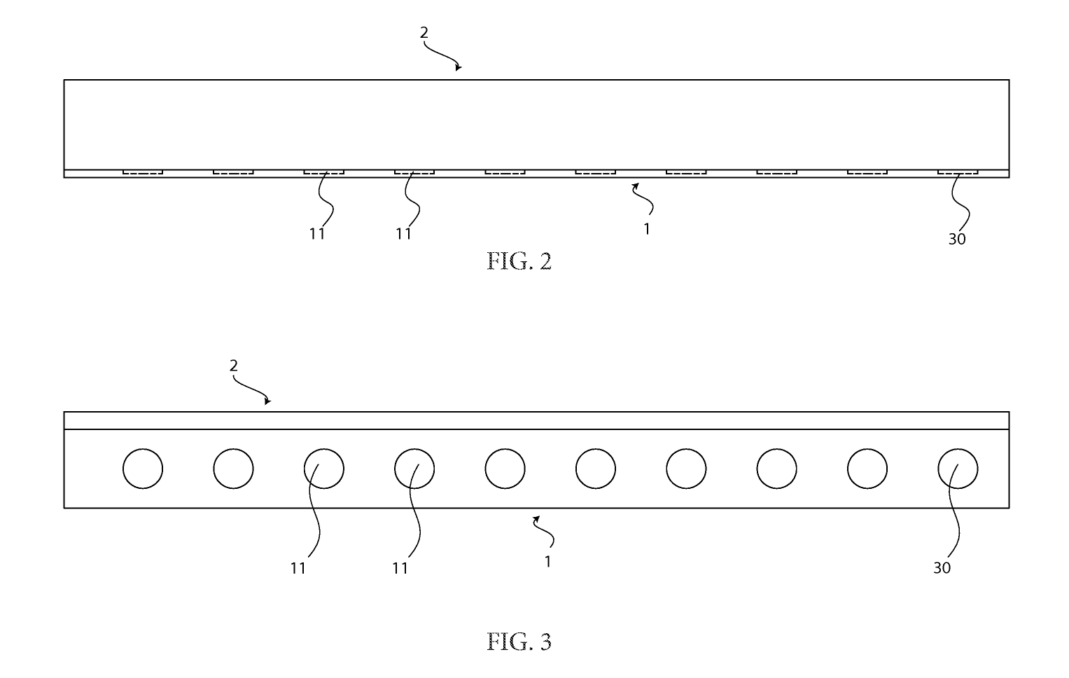

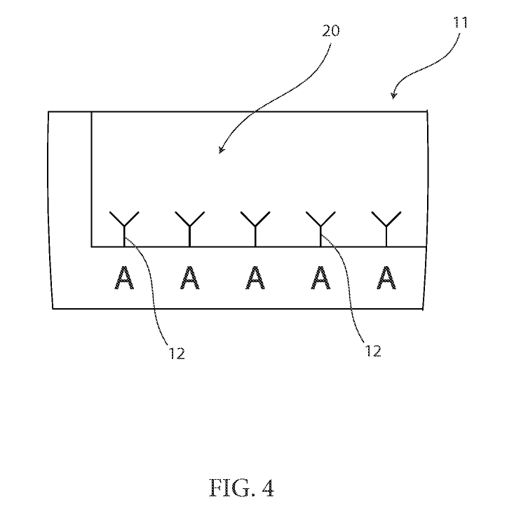

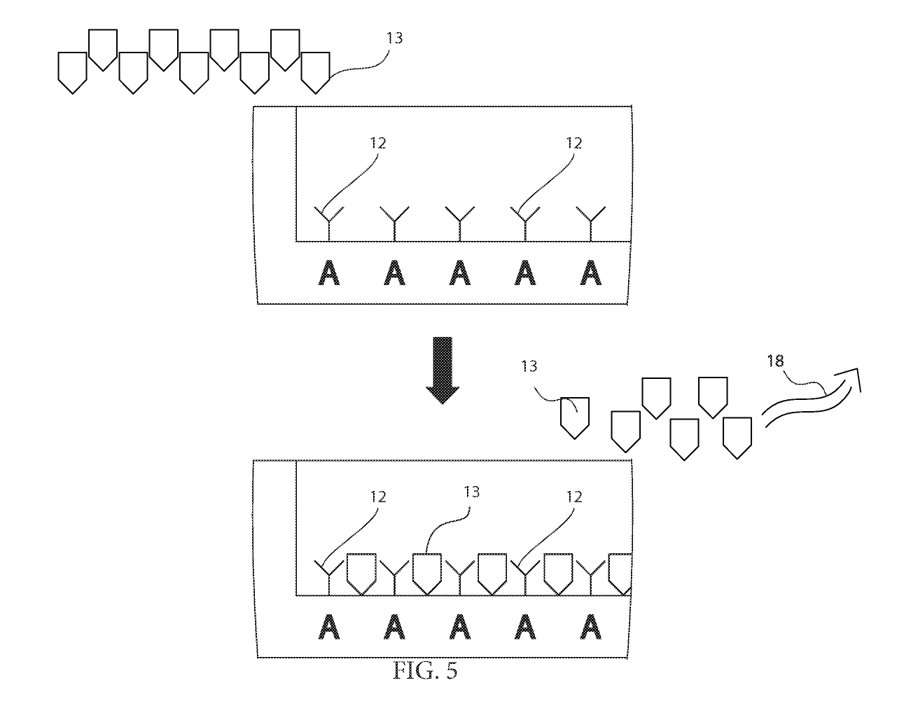

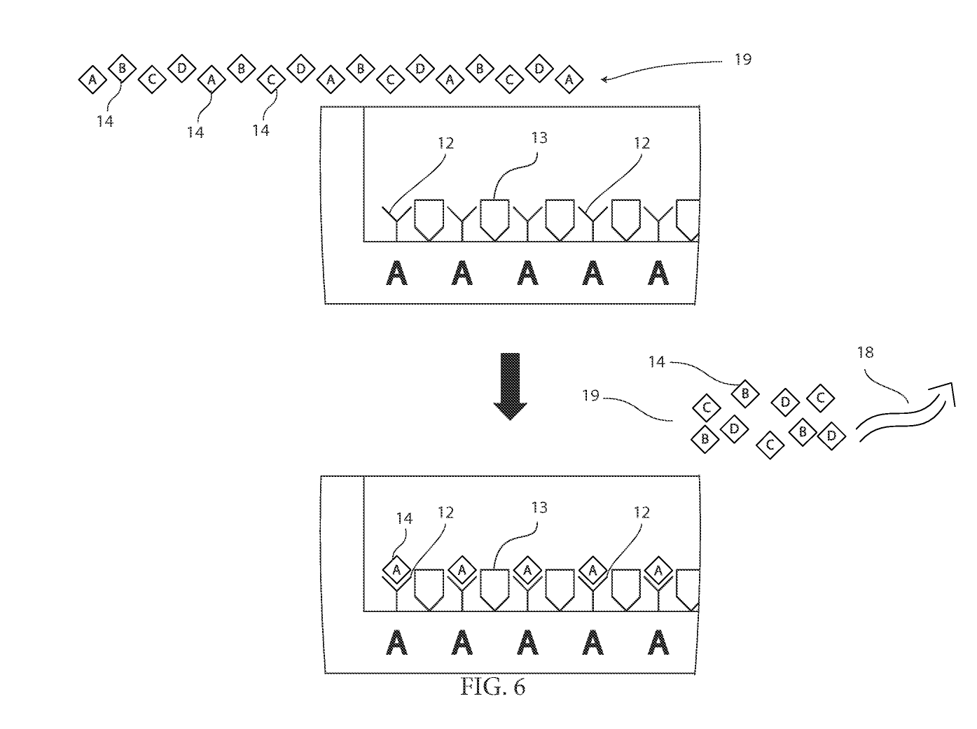

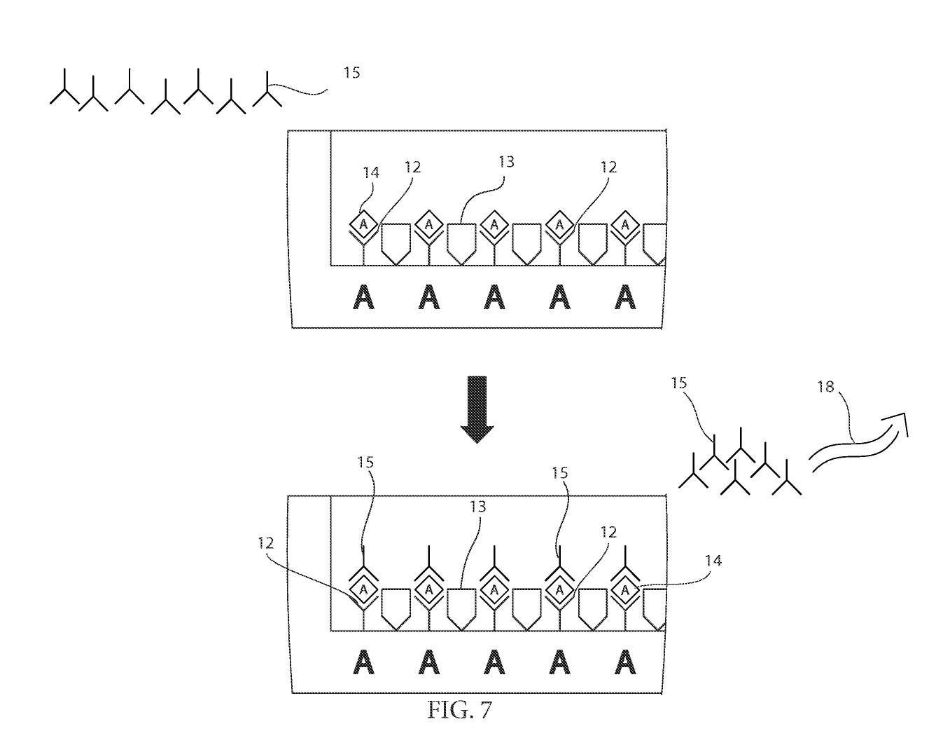

### DETAIL DESCRIPTIONS OF THE INVENTION

All illustrations of the drawings are for the purpose of describing selected versions of the present invention and are not intended to limit the scope of the present invention.

An enhanced immunosorbent spot test device allows low cost multiplex testing for single or multiple analytes in a single specimen. The present invention comprises of a membrane 1 and a carrier 2. The membrane 1 of the preferred embodiment is a hydrophilic PVDF membrane that is bound to the carrier 2 or optionally used as a stand-alone membrane 1 placed inside a conical tube. The membrane 1 comprises of a plurality of specific analyte detectors 11 and a control spot 30, as indicated by circular marks on the membrane. Each of the plurality of specific analyte detectors 11 comprise of a unique calibrated antigen 20. The calibrated antigen further comprise of a plurality of binding sites 12 which bind to a plurality of specific analyte 14 to be tested for. A wash buffer 18 is created by combining a wash buffer concentrate, distilled water, and a blocking buffer. The resulting wash buffer 18 contains a plurality of blockers 13. When the wash buffer 18 is applied to the membrane 1, the plurality of blockers 13 blocks open sites on the membrane 1 to allow a specimen 19 to react with only the calibrated antigen 20.

A method of use for the enhanced immunosorbent spot test device comprises of a plurality of steps. In the initial setup phase, the user makes a wash buffer 18 by bringing a bottle of a specimen diluent wash buffer concentrate to 500 ml by adding distilled water. Following, add the entire contents of one bottle of a provided blocking buffer and mix well to yield the wash buffer 18. To prepare the specimen 19 to be used for testing, the user creates a 1:101 dilution by mixing 2 ml of the prepared wash buffer 18 with 20 μl of a concentrated specimen and mixes well. The resulting diluted specimen 19 is used in the enhanced immunosorbent spot test and contains a plurality of blockers 13.

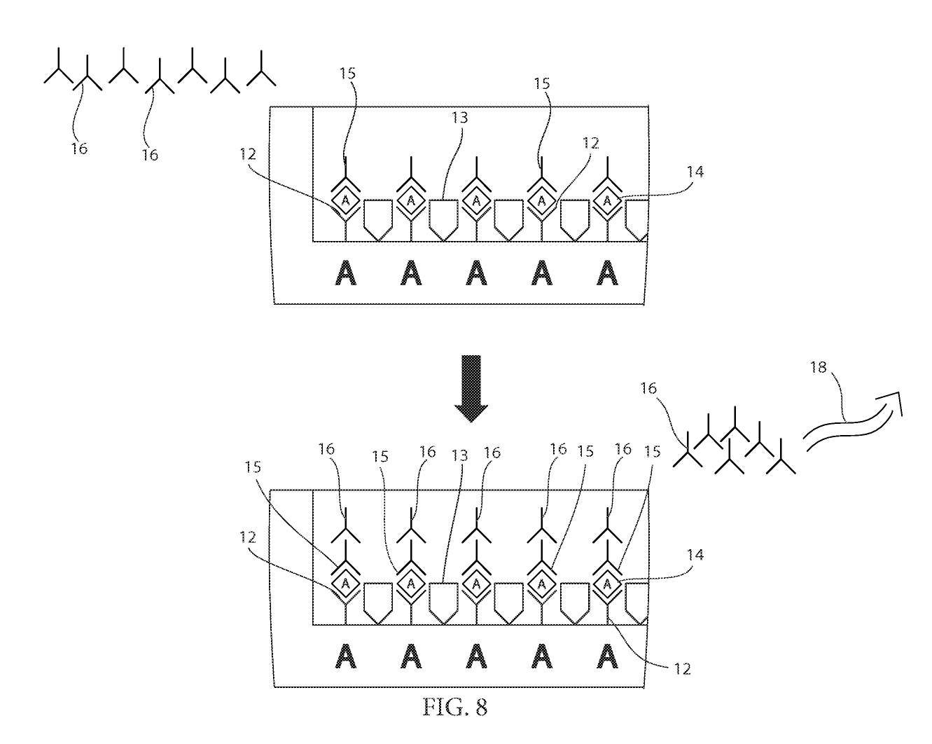

In the serum incubation stage, the user inserts the membrane 1 and attached carrier 2 into a channel of an incubation tray insuring that the membrane 1 is against the floor of the channel and that the carrier 2 is securely wedged into the channel. Using a transfer pipette, transfer the specimen 19 into an appropriate channel in the incubation tray. Rock the tray several times to mix and insure that the membrane 1 is fully covered by the diluted specimen 19. Incubate at room temperature for thirty minutes. In this stage, a plurality of specific analyte 14 binds to the plurality of binding sites 12 which have been calibrated to accept the specific analyte 14 to be tested for. Each calibrated antigen 20 on the membrane 1 is uniquely calibrated to receive a plurality of a specific analyte 14 to be tested for. All other specific analytes 14 not to be tested for on the particular calibrated antigen 20 will not bind to the plurality of binding sites 12 of the calibrated antigen 20. As exemplified in FIG. 8, this particular specific analyte detector 11 comprises of a calibrated antigen 20 allowing only sample analyte A to bind to the plurality of binding sites 12. The presence of analyte A in the specimen 19 binds to the plurality of binding sites 12 while the remaining analytes in the specimen 19 do not bind.

In the first wash stage, the user picks up the incubation tray and rests it against the palm of his or her hand with the thumb gently crossing over the top of the device carrier 2. Invert the tray and dump excess fluid as the carrier 2 holds the membrane 1 in place. Wash the membrane 1 by directing a stream of the wash buffer 18 directly along the membrane 1 and completely fill each channel of the incubation tray. Proceed to dump excess fluid. Repeat the first wash stage four additional times for a total of five total repetitions. After the final wash, shake the incubation tray five to six times to remove excess liquid. In this stage, excess of the diluted specimen 19 is washed away along with analytes in the specimen 19 which did not bind to the plurality of binding sites 12. As exemplified in FIG. 8, the result is the plurality of specific analyte 14 sample A which have bound to the plurality of binding sites 12 with remaining analytes washed away by the wash buffer 18.

In the first conjugate incubation stage, the user adds 2 ml of a first conjugate 15 to the membrane 1 and proceeds to rock the incubation tray several times to mix and insure that the membrane 1 is fully covered. Then, incubate at room temperature for twenty minutes. The first conjugate 15 is a biotin complex used for marking the plurality of specific analyte 14 bound to the plurality of binding sites 12. In this stage, the first conjugate 15 binds to the plurality of specific analyte 14 which remains on the membrane 1 and marks the plurality of specific analyte 14. As seen in FIG. 10, the first conjugate 15 binds to the specific analyte 14 sample A and acts as a marker.

In the second wash stage, the user repeats the process of the first wash stage by picking up the incubation tray and resting it against the palm of his or her hand with the thumb gently crossing over the top of the device carrier 2. Invert the incubation tray and dump excess fluid as the carrier 2 holds the membrane 1 in place. Wash the membrane 1 by directing a stream of the wash buffer 18 directly along the membrane 1 and completely fill each channel of the incubation tray. Proceed to dump excess fluid. Repeat the second wash stage four additional times for a total of five total repetitions. After the final wash, shake the incubation tray five to six times to remove excess liquid. In this stage, excess of the first conjugate 15 which did not bind to the specific analyte 14 is washed away. As seen in FIG. 10, the result is the first conjugate 15 bound to the specific analyte 14 sample A with excess of the first conjugate 15 washed away by the wash buffer 18.

In the second conjugate incubation stage, the user adds 2 ml of a second conjugate 16 to membrane 1 and proceeds to rock the incubation tray several times to mix and insure that the membrane 1 is fully covered. Then, incubate at room temperature for twenty minutes. The second conjugate 16 is a streptavidin complex used for marking the plurality of specific analyte 14 bound to the plurality of binding sites 12. The second conjugate 16 binds to the first conjugate 15 which has been binded to the plurality of specific analyte 14. In this stage, the second conjugate 16 binds to the first conjugate 15 and further marks the plurality of specific analyte 14. As seen in FIG. 12, the second conjugate 16 binds to the first conjugate 15 and acts as a marker.

In the third wash stage, the user repeats the process of the second wash stage by picking up the incubation tray and resting it against the palm of his or her hand with the thumb gently crossing over the top of the device carrier 2. Invert the incubation tray and dump excess fluid as the carrier 2 holds the membrane 1 in place. Wash the membrane 1 by directing a stream of the wash buffer 18 directly along the membrane 1 and completely fill each of the channels of the incubation tray. Proceed to dump excess fluid. Repeat the third wash stage four additional times for a total of five total repetitions. After the final wash, shake the incubation tray five to six times to remove excess liquid. In this stage, excess of the second conjugate 16 which did not bind to the first conjugate 15 is washed away. As seen in FIG. 12, the result is the second conjugate 16 bound to the first conjugate 15 with excess of the second conjugate 16 washed away by the wash buffer 18.

In the chromogen stage, the user adds 2 ml of a chromogen 17 to each channel of the incubation tray and proceeds to rock the tray several times to mix and insure that the membrane 1 is fully covered. Then, incubate at room temperature for five minutes. In this stage, the chromogen 17 binds to the second conjugate 16 and the first conjugate 15 present on the membrane, as seen in FIG. 14.

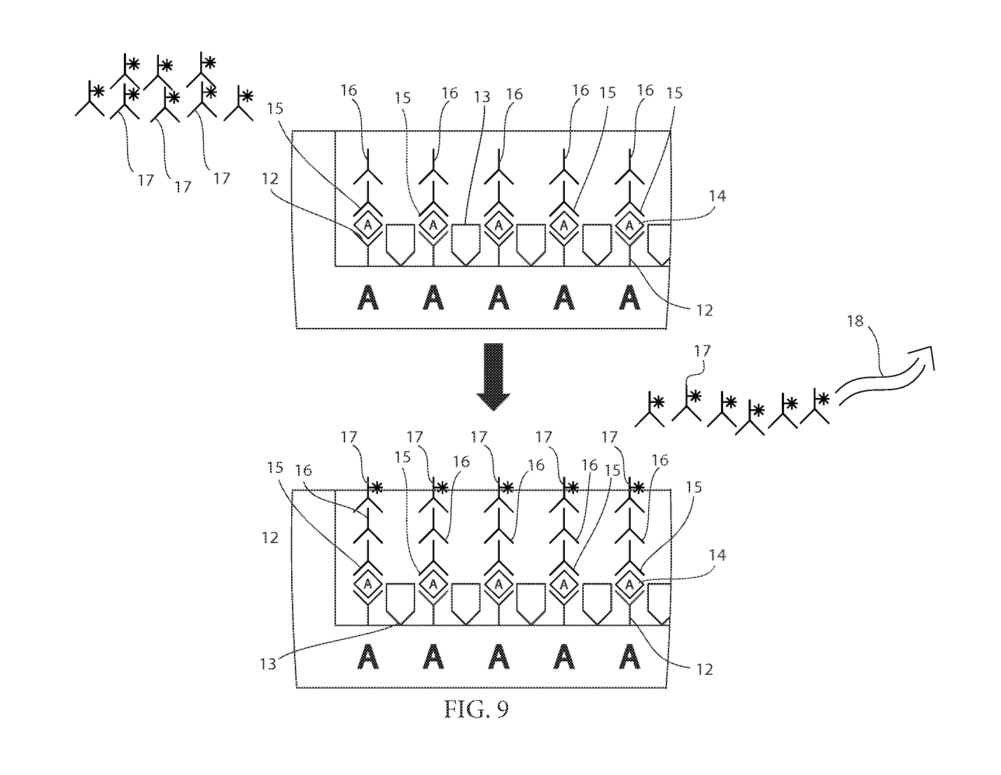

In the final stop and dying stage, the user picks up the incubation tray with membrane 1 and carrier 2 and rests it against the palm of his or her hand with the thumb gently crossing over the top of the device carrier 2. Invert the incubation tray and dump excess fluid as the carrier 2 holds the membrane 1 in place. Wash the membrane 1 by directing a stream of the wash buffer 18 directly along the membrane 1 and completely fill each of the channels of the incubation tray. Proceed to dump excess fluid. Repeat this process one additional time for a total of two total repetitions. Finally, remove the carrier 1 from the incubation tray and place on a paper towel to dry for at least thirty minutes. The membrane 1 should read within forty-eight hours after the start of the drying period. Any purple color present on the plurality of specific analyte detectors 11 is indicative of the associated antibody present to that antigen and further testing is suggested. As seen in FIG. 9, the chromogen 17 is present on the exemplified specific analyte detector 11 as the chromogen 17 has bound to the first conjugate 15 and the second conjugate 16 which have bound to the plurality of specific analyte 14 to be tested for. In the example, sample analyte A was present in the specimen 19 and the resulting presence of the chromogen 17 after the drying period yields a purple color to show a positive result.

In the preferred embodiment, a control spot 30 is positioned on the membrane 1 and must also yield a purple color due to the presence of the chromogen 17 for the test to be valid. The membrane 1 is opaque white in color to allow ease of reading the presence of purple color indicating a positive result, without the need for an optical reader. The present invention provides “present or not present” data to determine the presence of an analyte as opposed to the quantifying quantity or degree.

Materials required for the test but not provided by the preferred embodiment of the present invention include: pipettes capable of delivering 20 μl and 2 ml, test tube rack to hold the diluted specimens, squeeze bottle for washing strips, and distilled or reagent grade water.

Reagents and membrane devices strips should be stored between 2-8° C. The wash buffer 18 should also be stored between 2-8° C. This diluted buffer is good for up to 10 days. Do not add fresh buffer to old buffer.

For serum collection and handling, this test utilizes the specimen's serum: coagulate the blood and remove the serum. The use of “bloody” sera is contra-indicated. Serum samples should be refrigerated as soon as possible after collection and tested within 48 hours. If the specimen is not to be tested within 48 hours after collection, the serum sample should be stored at 0° C. or lower. Do not heat-inactivate serum and avoid repeated freezing and thawing of samples. Vortex (mix well) all samples before using. Do not use pooled specimens as this will adversely affect the performance of the assay. Test samples are diluted 1:101 in the Specimen Diluent/Wash Buffer (20 μl of sera+2 ml of Specimen Diluent/Wash Buffer) All Reagents must be at room temperature before beginning the assay.

Allow all reagents and samples to come to room temperature before testing. It is normal for the concentrated wash buffer to crystallize when cold. The crystals will re-dissolve once the solution returns to room temperature. Do not use reagents beyond the expiration date printed on the label. Do not reuse provided test tubes, transfer pipettes, or channels in the incubation tray or the membranes. Do not touch the membrane portion of the present invention. Do not inter-mix conjugates between different kits or different lot numbers of the same kit: these components are balanced to work together as a unit. The chromogen, blocking buffer, and wash buffer are universal reagents and can be inter-changed between all kits.

The membrane and carrier devices are shipped flat and must be “bent” into the working configuration at the time of use. Place the device on a dry flat surface and gently bend the carrier up so that the mouse symbol is on the top left side. The membrane will sit flat against the incubation tray floor and the carrier will be straight up in the incubation channel to hold the device in place. Procedures and reagents should be performed at room temperature (15-25° C.).

To troubleshoot: If the control spot is not visible the test is not valid. Recheck your procedure and insure that all reagents are at room temperature before starting the assay. If all the spots have visible color or there is a high degree of background staining usually indicates incomplete washing. Washing is extremely important in all assays, and incomplete washing leaves behind excess reagents that may give false positive results. Also check the three “T′s”: Time, Temperature and Technique. Time: insure that the timing on the incubation stages is adhered to. Temperature: temperatures above 25° C. may adversely affect the assay; Technique: check all pipettes to insure that they are properly delivering the correct volume to produce a 1:101 dilution of the specimens.

For reading results: allow the test membrane to dry for at least 30 minutes before reading and should be read within 48 hours after the start of the drying period. Drying time is dependent upon lab conditions (temperature and humidity). The Control spot must be visible for the test to be valid. Any purple color in a specific antigen spot is indicative of antibody present to that specific antigen and further testing is required by an alternate method.

The normal expected value is negative. Studies have shown that antibodies may take up to 21 days to appear after exposure; therefore, negative specimen results should be reviewed in relation to a possible exposure date. The present invention is designed as a screening assay and positive specimen results should be confirmed by an alternate method. Although uncommon, false positive results may occur from non-specific antibodies binding to the media in which the antigen is derived.

Although the invention has been explained in relation to its preferred embodiment, it is to be understood that many other possible modifications and variations can be made without departing from the spirit and scope of the invention as hereinafter claimed.

What is claimed is:

1. An apparatus for an enhanced immunosorbent spot test device comprises,
a membrane;
a carrier;
the membrane comprising a plurality of specific analyte detectors and a control spot;
the plurality of specific analyte detectors comprising of a plurality of binding sites, a plurality of blockers, a wash buffer, a plurality of specific analyte, a first conjugate, a second conjugate, a chromogen, a wash buffer, and a specimen; and
the plurality of specific analyte detectors being evenly spaced along the membrane.

2. The apparatus for an enhanced immunosorbent spot test device as claimed in claim 1 comprises,
the membrane being attached to the carrier; and
the plurality of binding sites comprising of a calibration.

3. A method of use for an enhanced immunosorbent spot test device comprises,
providing a wash buffer concentrate;
combining the wash buffer concentrate with 500 ml of distilled water to create a wash buffer;
combining 2 ml of the wash buffer with 20 μl of a concentrated specimen to create a specimen;

4. The method of use for an enhanced immunosorbent spot test device as claimed claim 3 comprises,
providing a membrane wherein the membrane comprises a plurality of specific analyte detectors and a control spot;
transferring the specimen to the membrane ensuring that the membrane is fully covered by the specimen; and
incubating the membrane at room temperature on an incubation tray for a time period of thirty minutes.

5. The method of use for an enhanced immunosorbent spot test device as claimed in claim 4 comprises,
inverting the carrier and dumping excess fluid;
washing the membrane by directing a stream of the wash buffer directly along the membrane to fill the plurality of wells;
upon filling the plurality of wells with wash buffer, inverting the carrier and dumping excess fluid; and
shaking the carrier to remove excess fluid.

6. The method of use for an enhanced immunosorbent spot test device as claimed in claim 5 comprises,
adding 2 ml of a first conjugate to the plurality of wells;
rocking the carrier to mix the fluid; and
incubating the membrane at room temperature on the incubation tray for a time period of twenty minutes.

7. The method of use for an enhanced immunosorbent spot test device as claimed in claim 6 comprises,
inverting the carrier and dumping excess fluid;
washing the membrane by directing a stream of the wash buffer directly along the membrane to fill the plurality of wells;
upon filling the plurality of wells with wash buffer, inverting the carrier and dumping excess fluid; and
shaking the carrier to remove excess fluid.

8. The method of use for an enhanced immunosorbent spot test device as claimed in claim 7 comprises,
adding 2 ml of a second conjugate to the plurality of wells;
rocking the carrier to mix the fluid; and
incubating the membrane at room temperature on the incubation tray for a time period of ten minutes.

9. The method of use for an enhanced immunosorbent spot test device as claimed in claim 8 comprises,
inverting the carrier and dumping excess fluid;
washing the membrane by directing a stream of the wash buffer directly along the membrane to fill the plurality of wells;
upon filling the plurality of wells with wash buffer, inverting the carrier and dumping excess fluid; and
shaking the carrier to remove excess fluid.

10. The method of use for an enhanced immunosorbent spot test device as claimed in claim 9 comprises,
adding 2 ml of a chromogen to the plurality of wells;
rocking the carrier to mix the fluid; and
incubating the membrane at room temperature on the incubation tray for a time period of five minutes.

11. The method of use for an enhanced immunosorbent spot test device as claimed in claim 10 comprises,
inverting the carrier and dumping excess fluid;
washing the membrane by directing a stream of the wash buffer directly along the membrane to fill the plurality of wells;
upon filling the plurality of wells with wash buffer, inverting the carrier and dumping excess fluid;
removing the carrier from the incubation tray and placing on a paper towel to dry for a time period of thirty minutes; and
reading the presence of a purple color present on the plurality of specific analyte detectors.
